(19) United States
(12) Patent Application Publication
(10) Pub. No.: US 2026/0052346 A1
(43) Pub. Date: Feb. 19, 2026

(54) SOUND MODULE AND ELECTRONIC DEVICE

(71) Applicant: GOERTEK INC., Weifang (CN)

(72) Inventors: Bobo LI, Weifang (CN); Xiaodong CAI, Weifang (CN)

(21) Appl. No.: 19/367,034

(22) Filed: Oct. 23, 2025

Related U.S. Application Data
(63) Continuation of application No. PCT/CN2025/078429, filed on Feb. 21, 2025.

(30) Foreign Application Priority Data
Jun. 27, 2024 (CN) 202410852317.1
Jun. 18, 2025 (CN) 202510823660.8

(51) Int. Cl. H04R 9/06; H04R 1/02; H04R 7/04; H04R 9/02; H04R 9/04

(52) U.S. Cl. CPC H04R 9/063; H04R 1/025; H04R 1/028; H04R 7/04; H04R 9/025; H04R 9/046

(57) ABSTRACT

A sound module includes a housing and a sound unit. The housing includes a housing; and a sound unit. The housing includes a first module housing and a second module housing provided along a first direction, the first module housing and the second module housing are enclosed to form an accommodating cavity. The sound unit is accommodated in the accommodating cavity and forms a front cavity and a rear cavity between the sound unit and the housing; and the sound unit includes a magnetic circuit system and a vibration system. The magnetic circuit system includes a plurality of magnetic circuit units distributed along a second direction, each of the magnetic circuit units includes a first magnetic assembly and a second magnetic assembly spaced apart along the first direction, and the second direction is perpendicular to the first direction.

### CROSS-REFERENCE TO RELATED APPLICATIONS

This application is a continuation application of International Application No. PCT/CN2025/078429, filed on Feb. 21, 2025, which claims priority to Chinese Patent Application No. 202410852317.1, filed on Jun. 27, 2024. This application also claims priority to Chinese Patent Application No. 202510823660.8, filed on Jun. 18, 2025. The disclosures of the above-mentioned applications are incorporated herein by reference in their entireties.

### TECHNICAL FIELD

The present application relates to the technical field of electroacoustic, and in particular to sound module and an electronic device using the sound module.

### BACKGROUND

At present, portable intelligent devices are becoming increasingly thin and light, especially foldable products. Therefore, terminal devices have an increasing demand for ultra-thin miniature sound modules, such as speaker modules.

A conventional DiPole Speaker (DPS) integrates two sets of vibration systems through a shared magnetic circuit. Both vibration systems require the whole-device side to reserve an upper vibration space and a sound outlet duct, and the two vibration systems have two diaphragms. Each diaphragm, when vibrating up and down, requires two vibration spaces, namely an upper vibration space and a lower vibration space. The two diaphragms then require four vibration spaces, which results in a large occupation of thickness space for DPS products. When the thickness of a DPS product decreases, in order to maintain the product performance under Equalizer (EQ) voltage, that is, to maintain the product at low frequency, the input voltage of the speaker is increased to push the displacement at each frequency point of the speaker to Xmax, thereby maximizing the product performance. Relatively large vibration spaces need to be reserved inside the product and at the whole-device side. Therefore, only the magnets, washers, and yokes in the magnetic circuit unit can be thinned.

However, an excessively thin magnetic circuit unit has a relatively high breakage rate during transportation, cleaning, and magnetizing, leading to a sharp rise in material cost.

Furthermore, since the magnets, washers, and yokes in the magnetic circuit unit are thinned to different degrees, the risk of drop damage increases, and the product reliability and yield will also decrease significantly, making mass production impossible.

### SUMMARY

The main objective of the present application is to provide a sound module and electronic device that can achieve a lightweight design and improve call privacy.

In order to achieve the above objective, the present application provides a sound module, which includes: a housing; and a sound unit.

The housing includes a first module housing and a second module housing provided along a first direction, the first module housing and the second module housing are enclosed to form an accommodating cavity; the sound unit is accommodated in the accommodating cavity and forms a front cavity and a rear cavity between the sound unit and the housing; and the sound unit includes a magnetic circuit system and a vibration system.

The magnetic circuit system includes a plurality of magnetic circuit units distributed along a second direction, each of the magnetic circuit units includes a first magnetic assembly and a second magnetic assembly spaced apart along the first direction, the second direction is perpendicular to the first direction, the first magnetic assembly has a first magnetic gap, and the second magnetic assembly has a second magnetic gap.

The vibration system includes a plurality of vibration units, each magnetic circuit unit corresponds to one vibration unit, each vibration unit is provided between the first magnetic assembly and the second magnetic assembly of the corresponding magnetic circuit unit, each vibration unit includes a diaphragm and a voice coil connected to the diaphragm, the diaphragm includes a vibration plate and a folded ring provided around the vibration plate along the second direction, the voice coil includes a first voice coil portion and a second voice coil portion located on opposite sides of the vibration plate along the first direction, the first voice coil portion is located in the first magnetic gap of the corresponding magnetic circuit unit, and the second voice coil portion is located in the second magnetic gap of the corresponding magnetic circuit unit.

In a first working state, at least one of the vibration units radiates sound waves of a first phase outward, and at least one of the remaining vibration units radiates sound waves of a second phase outward, the first phase and the second phase are opposite phases; the housing is provided with a sound outlet hole corresponding to each of the vibration units, the sound outlet hole communicates with the front cavity, and the sound waves generated by each of the vibration units are radiated outward through the corresponding sound outlet hole.

In an embodiment, in the first working state, two adjacent vibration assemblies respectively radiate sound waves of the first phase and the second phase outward, each of the vibration assemblies includes one vibration unit or multiple adjacent vibration units, and numbers of the vibration units in the two adjacent vibration assemblies are the same.

In an embodiment, a difference in the numbers of the vibration units in the two adjacent vibration assemblies is one or two.

In an embodiment, in a second working state, the plurality of vibration units radiate sound waves of the same phase outward, and the second working state differs from the first working state.

In an embodiment, in each of the vibration units, the first voice coil portion and the second voice coil portion are wound by a same wire, and the vibration plate includes an inner vibration plate connected to an inner wall of the voice coil and an outer vibration plate connected to an outer wall of the voice coil.

In an embodiment, the inner vibration plate includes an inner flat plate portion and an inner bending portion extending from an outer edge of the inner flat plate portion and connected to the inner wall of the voice coil; and/or, the outer vibration plate includes an outer flat plate portion and an outer bending portion extending from an inner edge of the outer flat plate portion and connected to the outer wall of the voice coil.

In an embodiment, one side of the second voice coil portion is connected to an external circuit.

In an embodiment, the first voice coil portion and the second voice coil portion are respectively wound by different conductive wires independently.

In an embodiment, the first magnetic gap includes a first part opposite to the first magnetic assembly in the second direction, and a second part located on a side of the first part facing the vibration plate in the first direction; the second magnetic gap includes a third part opposite to the second magnetic assembly in the second direction, and a fourth part located on a side of the third part facing the vibration plate in the first direction; and magnetic flux lines of the first magnetic assembly pass through the first voice coil portion at the second part and magnetic flux lines of the second magnetic assembly pass through the second voice coil portion at the fourth part.

In an embodiment, the first voice coil portion and the second voice coil portion are wound from a same wire to form an integrated voice coil extending along the first direction, the voice coil has a height along the first direction and a thickness along the second direction, the height of the voice coil is greater than the thickness of the voice coil; two ends of the voice coil respectively oppose the first part and the third part, and a width of the voice coil is less than widths of the first part and the third part.

In an embodiment, part or all of the first voice coil portion is located in the second part and part or all of the second voice coil portion is located in the fourth part.

In an embodiment, the sound unit further includes a housing. In each of the vibration units, the folded ring includes a first connecting portion, a deformable portion, and a second connecting portion sequentially connected along the second direction, the first connecting portion is connected to the vibration plate, the second connecting portion is connected to the housing, and the deformable portion is recessed toward a side on which the second magnetic assembly is located.

In an embodiment, in each of the vibration units, two ends of the folded ring along the first direction are respectively a first end and a second end, the first end is connected to an edge of the vibration plate, the second end is connected to the housing or to the second magnetic assembly, the first end is located on a same side as the first magnetic assembly, and the second end is located on a same side as the second magnetic assembly.

In an embodiment, the first magnetic assembly includes a first inner magnet and a first outer magnet provided along the second direction, and the first magnetic gap is formed between the first inner magnet and the first outer magnet; the second magnetic assembly includes a second inner magnet and a second outer magnet provided along the second direction, and the second magnetic gap is formed between the second inner magnet and the second outer magnet; sides of the first inner magnet and the first outer magnet facing the vibration plate form a surface of the first magnetic assembly, and sides of the second inner magnet and the second outer magnet facing the vibration plate form a surface of the second magnetic assembly.

In an embodiment, the first voice coil portion and the second voice coil portion are wound from a same wire to form an integrated voice coil extending along the first direction, the voice coil has a height along the first direction and a thickness along the second direction, the height of the voice coil is greater than the thickness of the voice coil; two ends of the voice coil respectively oppose the first part and the third part, and a width of the voice coil is less than widths of the first part and the third part.

In an embodiment, part or all of the first voice coil portion is located in the second part and part or all of the second voice coil portion is located in the fourth part.

In an embodiment, the sound unit further includes a housing; in each of the vibration units, the folded ring includes a first connecting portion, a deformable portion, and a second connecting portion sequentially connected along the second direction, the first connecting portion is connected to the vibration plate, the second connecting portion is connected to the housing, and the deformable portion is recessed toward a side on which the second magnetic assembly is located.

In an embodiment, in each of the vibration units, two ends of the folded ring along the first direction are respectively a first end and a second end, the first end is connected to an edge of the vibration plate, the second end is connected to the housing or to the second magnetic assembly, the first end is located on a same side as the first magnetic assembly, and the second end is located on a same side as the second magnetic assembly.

In an embodiment, the first magnetic assembly includes a first inner magnet and a first outer magnet provided along the second direction, and the first magnetic gap is formed between the first inner magnet and the first outer magnet; the second magnetic assembly includes a second inner magnet and a second outer magnet provided along the second direction, and the second magnetic gap is formed between the second inner magnet and the second outer magnet; sides of the first inner magnet and the first outer magnet facing the vibration plate form a surface of the first magnetic assembly, and sides of the second inner magnet and the second outer magnet facing the vibration plate form a surface of the second magnetic assembly.

In an embodiment, in each of the magnetic circuit units, magnetic poles of the first inner magnet and the second inner magnet are opposite, magnetic poles of the first outer magnet and the second outer magnet are opposite, and magnetic poles of the first inner magnet and the first outer magnet are opposite; and/or, the first magnetic gap and the second magnetic gap are aligned along the first direction; and/or, the first outer magnet is a ring magnet; and/or, the first inner magnet and the second inner magnet are provided opposite to each other, and the first outer magnet and the second outer magnet are provided opposite to each other.

In an embodiment, in each of the vibration units, a conductive layer is provided on a surface of the folded ring, and the voice coil is electrically connected to the conductive layer; the sound unit further includes a housing, and a conductive terminal is injection-molded onto the housing; the conductive layer and the conductive terminal are connected via conductive adhesive, such that the voice coil is electrically connected to the conductive terminal through the conductive layer.

In an embodiment, each of the vibration units further includes a centering support plate, the centering support plate is conductive, and the second voice coil portion is connected to an external circuit via the centering support plate.

In an embodiment, the sound unit further includes a housing, the housing has a plurality of accommodating spaces distributed along the second direction, each accommodating space is configured to accommodate one magnetic circuit unit correspondingly; the housing includes a plastic bracket, a first metal plate, and a second metal plate respectively provided on both sides of the plastic bracket along the first direction, the plastic bracket, the first metal plate, and the second metal plate encloses the accommodating spaces, the first magnetic assembly is provided on the first metal plate, and the second magnetic assembly is provided on the second metal plate; and the first metal plate is embedded in the first module housing, and the second metal plate is embedded in the second module housing.

In an embodiment, the first metal plate and/or the second metal plate are made of magnetic conductive materials; and/or, the sound outlet holes are provided on a same side wall of the housing.

In an embodiment, in each of the vibration units, the first voice coil portion and the second voice coil portion are wound by the same wire, and the vibration plate includes an inner vibration plate connected to an inner wall of the voice coil and an outer vibration plate connected to an outer wall of the voice coil; and the magnetic poles of the first inner magnet and the second inner magnet are opposite, and the inner vibration plate has a magnetic conductive portion.

In an embodiment, the inner vibration plate is magnetically conductive to form the magnetic conductive portion.

In an embodiment, a magnetic conductive member is embedded in the inner vibration plate to form the magnetic conductive portion.

In an embodiment, a magnetic conductive member is provided on at least one side of the inner vibration plate along the first direction to form the magnetic conductive portion.

In an embodiment, at least one surface of the inner vibration plate along the first direction is coated with a magnetic conductive material to form the magnetic conductive portion.

In an embodiment, the rear cavity is filled with a sound-absorbing material, the second module housing is provided with a filling port for the sound-absorbing material, and the second module housing further includes a damper for sealing the filling port.

The present application further provides an electronic device, including a device housing and the sound module as described above.

In the sound module of the present application, each magnetic circuit unit includes a first magnetic assembly and a second magnetic assembly respectively provided on upper and lower sides of the vibration unit, thereby achieving a dual magnetic circuit design of the sound unit. This design enables the magnetic field distribution in the vibration region of the voice coil to be uniform, provides a greater and smoothly varying flat driving force for the voice coil, and reduces distortion risk.

Moreover, compared with conventional DiPole Speaker (DPS), in the sound unit of the present application, a plurality of magnetic circuit units and a plurality of vibration units are distributed along the horizontal direction, which does not occupy excessive space in the vertical thickness of the housing. All vibration units require only two vibration spaces, namely an upper vibration space and a lower vibration space, when vibrating up and down, without additionally occupying the thickness space of the sound unit, thereby facilitating the realization of a thin design.

In addition, the first working state of the sound module of the present application may be a receiver state. In the receiver state, at least one vibration unit radiates sound waves of a first phase outward, and at least one of the remaining vibration units radiates sound waves of a second phase outward. The first phase and the second phase are opposite, forming a dipole effect with a far-field noise-canceling technical effect, thereby improving call privacy. Moreover, the sound waves of each vibration unit are radiated to the outside through a corresponding sound outlet hole, that is, each vibration unit corresponds to one sound outlet hole and emits sound therefrom, preventing mutual interference between sounds and improving acoustic performance.

### BRIEF DESCRIPTION OF THE DRAWINGS

In order to more clearly illustrate the technical solutions in the embodiments of the present application or in the related art, the drawings required for the description of the embodiments or the related art are briefly introduced below. It is apparent that the drawings in the following description merely show some embodiments of the present application. For those of ordinary skill in the art, other drawings can also be obtained based on the structures shown in these drawings without creative efforts.

FIG. 1 is a schematic structural diagram of an assembly of a sound module according to an embodiment of the present application.

FIG. 2 is a schematic cross-sectional diagram of the sound module according to an embodiment of the present application.

FIG. 3 is an exploded schematic structural diagram of the sound module according to another embodiment of the present application.

FIG. 4 is a schematic cross-sectional diagram of a sound unit according to another embodiment of the present application.

FIG. 5 is an exploded schematic structural diagram of the sound unit according to an embodiment of the present application.

FIG. 6 is a schematic cross-sectional diagram of the sound unit according to another embodiment of the present application.

FIG. 7 is an exploded schematic structural diagram of the sound unit according to another embodiment of the present application.

FIG. 8 is another schematic cross-sectional diagram of the sound module according to an embodiment of the present application.

FIG. 9 is a schematic diagram illustrating a magnetic field distribution of the sound unit according to an embodiment of the present application.

FIG. 10 is a schematic diagram illustrating a BL(x) curve of the sound unit according to an embodiment of the present application.

FIG. 11 is a schematic diagram illustrating magnetization of a vibration unit in a sound unit according to an embodiment of the present application.

FIG. 12 is a schematic cross-sectional diagram of a voice coil and a diaphragm in the sound unit according to an embodiment of the present application.

FIG. 13 is a schematic cross-sectional diagram of the voice coil and the diaphragm in the sound unit according to another embodiment of the present application.

FIG. 14 is a schematic cross-sectional diagram of the voice coil and the diaphragm in the sound unit according to another embodiment of the present application.

FIG. 15 is a schematic structural diagram of a folded ring in the sound unit according to an embodiment of the present application.

FIG. 16 is a schematic structural diagram of a second bracket in the sound unit according to an embodiment of the present application, in which the second bracket adopts an integrated design.

FIG. 17 is a schematic structural diagram of a second bracket in the sound unit according to an embodiment of the present application, in which the second bracket adopts a split design.

FIG. 18 is a schematic structural diagram of a first module housing and a first bracket in the sound module according to an embodiment of the present application.

FIG. 19 is a schematic structural diagram of a second module housing and a second bracket in the sound module according to an embodiment of the present application.

FIG. 20 is a schematic cross-sectional diagram of an inner vibration plate and a magnetic conductive member in the sound unit according to an embodiment of the present application.

The realization of the purpose, functional features and advantages of the present application will be further described with reference to the embodiments and the accompanying drawings.

### DETAILED DESCRIPTION OF THE EMBODIMENTS

The technical solutions in the embodiments of the present application will be clearly and fully described below with reference to the accompanying drawings in the embodiments of the present application. It is apparent that the described embodiments are merely some of the embodiments of the present application, rather than all of the embodiments. Based on the embodiments of the present application, all other embodiments obtained by those of ordinary skill in the art without creative efforts shall fall within the protection scope of the present application.

It should be noted that, if directional indications such as “upper,” “lower,” “left,” “right,” “front,” and “rear” are involved in the embodiments of the present application, such directional indications are merely used to illustrate the relative positional relationships or movement conditions among the components under a specific posture (as shown in the drawings). When the specific posture changes, the corresponding directional indications shall change accordingly.

In addition, if descriptions such as “first” and “second” are involved in the embodiments of the present application, such descriptions are merely used for the purpose of distinction and should not be understood as indicating or implying their relative importance or implicitly specifying the number of the indicated technical features. Therefore, a feature defined as “first” or “second” may explicitly or implicitly include at least one such feature. Furthermore, the technical solutions among the various embodiments may be combined with each other, but such combinations must be based on the realization capability of those skilled in the art. When the combination of technical solutions leads to contradictions or cannot be realized, it shall be understood that such combination does not exist and is not within the protection scope of the present application.

At present, portable intelligent devices are becoming increasingly thin and light, especially foldable products. Therefore, terminal devices have an increasing demand for ultra-thin miniature sound modules, such as speaker modules.

A conventional DiPole Speaker (DPS) integrates two sets of vibration systems through a shared magnetic circuit. Both vibration systems require the whole-device side to reserve an upper vibration space and a sound outlet duct, and the two vibration systems have two diaphragms. Each diaphragm, when vibrating up and down, requires two vibration spaces, namely an upper vibration space and a lower vibration space. The two diaphragms then require four vibration spaces, which results in a large occupation of thickness space for DPS products. When the thickness of a DPS product decreases, in order to maintain the product performance under Equalizer (EQ) voltage, that is, to maintain the product at low frequency, the input voltage of the speaker is increased to push the displacement at each frequency point of the speaker to Xmax, thereby maximizing the product performance. Relatively large vibration spaces need to be reserved inside the product and at the whole-device side. Therefore, only the magnets, washers, and yokes in the magnetic circuit unit can be thinned. However, an excessively thin magnetic circuit unit has a relatively high breakage rate during transportation, cleaning, and magnetizing, leading to a sharp rise in material cost. Furthermore, since the magnets, washers, and yokes in the magnetic circuit unit are thinned to different degrees, the risk of drop damage increases, and the product reliability and yield will also decrease significantly, making mass production impossible.

In view of this, it is necessary to provide a sound module and an electronic device to solve or at least alleviate the above technical problems.

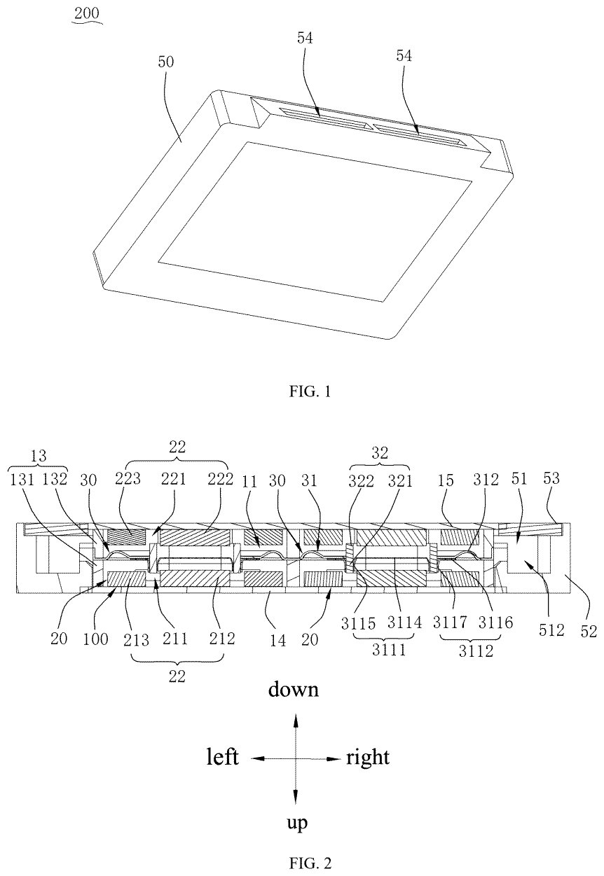

As shown in FIG. 1 to FIG. 8, the present application provides a sound module 200. The sound module 200 includes a housing 50 and a sound unit 100. The housing 50 includes a first module housing 52 and a second module housing 53 provided along a first direction, and the first module housing 52 and the second module housing 53 enclose an accommodating cavity 51. The sound unit 100 is accommodated in the accommodating cavity 51 and forms a front cavity 511 and a rear cavity 512 between the sound unit 100 and the housing 50.

The sound unit 100 includes a magnetic circuit system and a vibration system. The magnetic circuit system includes a plurality of magnetic circuit units 20 distributed along a second direction. Each magnetic circuit unit 20 includes a first magnetic assembly 21 and a second magnetic assembly 22 spaced apart along a first direction. The second direction is perpendicular to the first direction. The first magnetic assembly 21 has a first magnetic gap 211, and the second magnetic assembly 22 has a second magnetic gap 221. The vibration system includes a plurality of vibration units 30. Each magnetic circuit unit 20 corresponds to one vibration unit 30. Each vibration unit 30 is disposed between the first magnetic assembly 21 and the second magnetic assembly 22 of the corresponding magnetic circuit unit 20. Each vibration unit 30 includes a diaphragm 31 and a voice coil 32 connected to the diaphragm 31. The diaphragm 31 includes a vibration plate 311 and a folded ring 312 provided around the vibration plate 311 along the second direction. The voice coil 32 includes a first voice coil portion 321 and a second voice coil portion 322 located on opposite sides of the vibration plate 311 along the first direction. The first voice coil portion 321 is located in the first magnetic gap 211 of the corresponding magnetic circuit unit 20, and the second voice coil portion 322 is located in the second magnetic gap 221 of the corresponding magnetic circuit unit 20.

In a first working state, at least one vibration unit 30 radiates sound waves of a first phase outward, and at least one of the remaining vibration units 30 radiates sound waves of a second phase outward. The first phase and the second phase are opposite phases. The housing 50 is provided with sound outlet holes 54 corresponding to the vibration units 30. The sound outlet holes 54 communicate with the front cavity 511, and the sound waves generated by the vibration units 30 are radiated outward through the corresponding sound outlet holes 54.

The sound unit 100 in the sound module 200 of the present application may be a speaker unit, specifically a DPS unit. The sound unit 100 may be applied in the sound module 200 of an electronic device. The electronic device may be a computer, a mobile phone, a tablet, or an intelligent wearable device. In the present embodiment, the sound module 200 is described as an example of a speaker module.

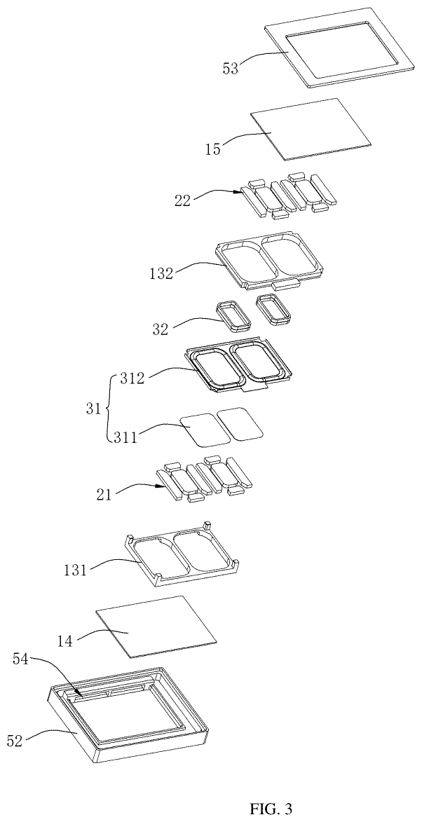

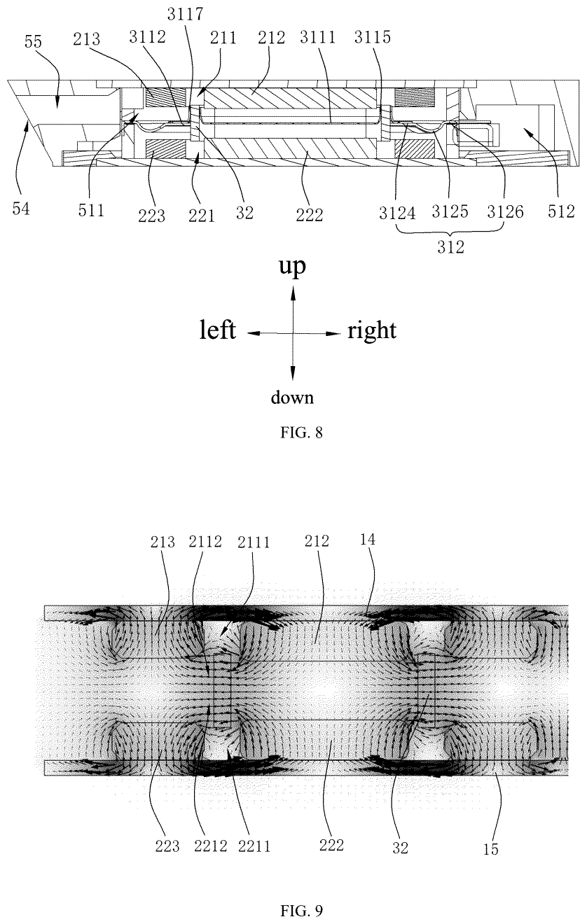

The first direction is a vertical direction as shown in FIG. 2 and FIG. 8, which represents an up-and-down direction. The second direction is a horizontal direction as shown in FIG. 2 and FIG. 8, which represents a direction parallel to a horizontal plane in which the left-right direction lies. The horizontal direction is perpendicular to the vertical direction.

In an embodiment, the housing 50 is provided with sound outlet holes 54. The housing 50 includes a first module housing 52 and a second module housing 53 provided along the first direction, that is, the first module housing 52 and the second module housing 53 are arranged along the up-and-down direction. The first module housing 52 is located on an upper side of the second module housing 53. The first module housing 52 and the second module housing 53 enclose an accommodating cavity 51 to accommodate the sound unit 100, thereby achieving a compact structure.

The sound unit 100 is accommodated in the accommodating cavity 51 and forms a front cavity 511 and a rear cavity 512 with the housing 50. The sound outlet hole 54 communicates with the front cavity 511 to enable normal sound emission of the sound module 200. Specifically, the housing 50 includes a sound guide channel for each vibration unit 30 to radiate sound waves, and the sound guide channel communicates with the sound outlet hole 54, so that the sound waves generated by air vibration driven by the vibration units 30 can be emitted through the sound guide channel and the sound outlet hole 54, thereby realizing normal sound emission of the sound module 200.

In the sound unit 100, the magnetic circuit system includes a plurality of magnetic circuit units 20 distributed along the second direction, that is, along the horizontal direction. Each magnetic circuit unit 20 corresponds to one vibration unit 30, so that both the plurality of magnetic circuit units 20 and the plurality of vibration units 30 are distributed along the horizontal direction. Each magnetic circuit unit 20 includes a first magnetic assembly 21 and a second magnetic assembly 22 which are spaced apart along the up-and-down direction. The vibration unit 30 is disposed between the first magnetic assembly 21 and the second magnetic assembly 22 of the corresponding magnetic circuit unit 20. The first magnetic assembly 21 is located on an upper side of the vibration unit 30, and the second magnetic assembly 22 is located on a lower side of the vibration unit 30. The first magnetic assembly 21 and the second magnetic assembly 22 provide a driving force for the voice coil 32 of the corresponding vibration unit 30, such that the voice coil 32 vibrates along the first direction, thereby driving the diaphragm 31 to vibrate along the first direction to realize sound generation through vibration.

The diaphragm 31 includes a vibration plate 311 and a folded ring 312. The folded ring 312 is provided around the vibration plate 311 along the second direction, that is, along the horizontal direction. In other words, the folded ring 312 and the vibration plate 311 are arranged along the horizontal direction, and the folded ring 312 is provided around a peripheral side of the vibration plate 311. The first voice coil portion 321 and the second voice coil portion 322 of the voice coil 32 are respectively located on an upper side and a lower side of the vibration plate 311. The first voice coil portion 321 is located in the first magnetic gap 211 of the corresponding magnetic circuit unit 20, and the second voice coil portion 322 is located in the second magnetic gap 221 of the corresponding magnetic circuit unit 20. When the voice coil 32 is energized, the first voice coil portion 321 and the second voice coil portion 322 reciprocally move within the first magnetic gap 211 and the second magnetic gap 221 respectively, cutting magnetic flux lines to drive the diaphragm 31 to vibrate up and down, thereby driving air vibration to generate sound and realizing energy conversion between electricity and sound.

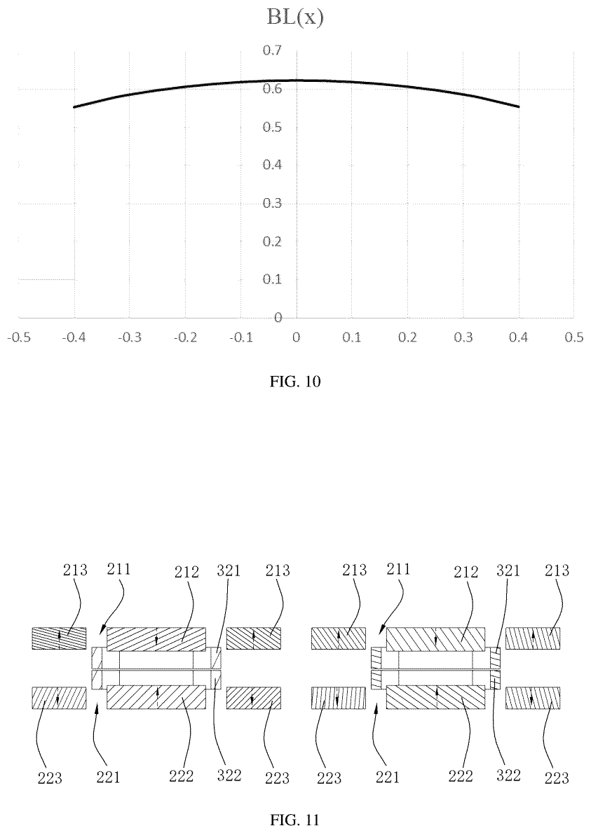

As shown in FIG. 9, in the sound module 200 of the present application, each magnetic circuit unit 20 includes a first magnetic assembly 21 and a second magnetic assembly 22 respectively provided on upper and lower sides of the vibration unit 30, thereby realizing a dual magnetic circuit design of the sound module 200. This allows the magnetic field distribution in the vibration region of the voice coil 32 to be uniform, and provides the voice coil 32 with a large and slowly varying flat driving force as the displacement changes, as illustrated by the BL(x) curve shown in FIG. 10, thereby reducing the risk of distortion.

As shown in FIG. 10, the BL(x) curve is completely symmetrical, and the BL value at the Xmax position (the maximum displacement of the voice coil 32) attenuates within 10% compared with the BL value at the equilibrium position, thereby achieving an ultra-linear BL(x) design. It can be understood that, in FIG. 10, the horizontal axis represents displacement in millimeters (mm), and the vertical axis represents BL in Weber per meter (Wb/m).

Moreover, compared with a conventional DPS speaker, in the sound module 200 of the present application, the plurality of magnetic circuit units 20 and the plurality of vibration units 30 are all distributed along the horizontal direction, which does not occupy excessive space in the vertical thickness of the housing 10. All the vibration units 30 require only two vibration spaces, namely an upper vibration space and a lower vibration space, when vibrating up and down, without additionally occupying the thickness space of the sound module 200, thereby facilitating a thin design. Therefore, under the same thickness, the sound module 200 of the present application can employ a thickened design of the magnetic circuit units 20 to maximize utilization of the thickness space of the product and the entire device, enhance the strength of the magnetic circuit units 20, reduce the risks of fragmentation and drop damage, thereby reducing material costs, improving product reliability and yield, and enabling mass production.

Furthermore, the first working state of the sound module 200 of the present application may be a receiver (RCV) state. In the RCV state, at least one vibration unit 30 radiates sound waves of a first phase outward, and at least one of the remaining vibration units 30 radiates sound waves of a second phase outward. The first phase and the second phase are opposite phases, thereby forming a dipole effect, which provides a technical effect of far-field noise cancellation and improves call privacy.

Further, in the first working state, two adjacent vibration assemblies respectively radiate sound waves of the first phase and the second phase outward. Each vibration assembly includes one vibration unit 30 or multiple adjacent vibration units 30, and the number of vibration units 30 in the two adjacent vibration assemblies is the same or close.

Specifically, the plurality of vibration units 30 are divided into different vibration assemblies, the number of the vibration assemblies being at least two. Each vibration assembly includes one vibration unit 30 or multiple adjacent vibration units 30. The number of vibration units 30 in two adjacent vibration assemblies is the same or close. It can be understood that the number of vibration units 30 in two adjacent vibration assemblies being close means that the difference in the number of vibration units 30 between the two vibration assemblies is one or two. In general, as long as the number difference between the two adjacent vibration assemblies is not large, it can avoid an imbalance in the number of vibration units 30 radiating opposite-phase sound waves outward, thereby preventing an adverse effect on call privacy.

For ease of description, the first phase is represented by “+”, and the second phase is represented by “−”.

In the receiver state, when the number of vibration units 30 is two, the radiation pattern is +, −;
when the number of vibration units 30 is three, the radiation patterns are +, +,−/+, −, −/+, −, +/−,+, −;
when the number of vibration units 30 is four, the radiation patterns are +, +, −, −/+, −, +, −, and the like;
when the number of vibration units 30 is five, the radiation patterns are +, +, +, −, −/+, +, −, −, +/+, −, +, −, +, and the like;
when the number of vibration units 30 is six, the radiation patterns are +, +, +, −, −, −/+, +, −, −, +, +/+, −, +, −, +, −, and the like.

By analogy, the phase modes of sound wave radiation of the plurality of vibration units 30 can be diversified and flexible to meet various requirements.

In an embodiment, in a second working state, the plurality of vibration units 30 radiate sound waves of the same phase outward, and the second working state differs from the first working state.

Specifically, the second working state of the sound unit 100 of the present application may be a speaker (SPK) state. In the SPK state, all the vibration units 30 radiate sound waves of the same phase outward. The sound waves of the same phase can be superimposed to enhance the playback effect and broaden the sound reproduction frequency band.

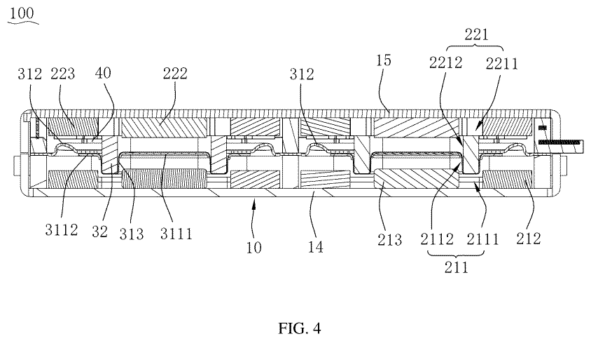

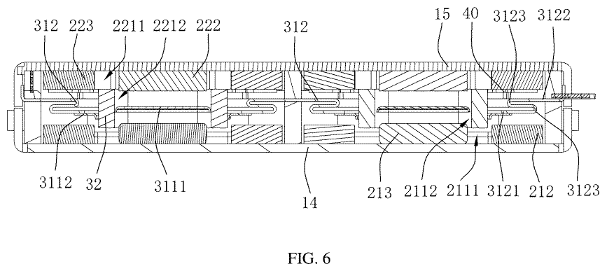

As shown in FIG. 2, FIG. 4, FIG. 6, and FIG. 8, and further in combination with FIG. 9, the first magnetic gap 211 includes a first part 2111 opposite to the first magnetic assembly 21 in the second direction, and a second part 2112 located on a side of the first part 2111 facing the vibration plate 311 in the first direction. The second magnetic gap 221 includes a third part 2211 opposite to the second magnetic assembly 22 in the second direction, and a fourth part 2212 located on a side of the third part 2211 facing the vibration plate 311 in the first direction. Part or all of the first voice coil portion 321 and the second voice coil portion 322 are respectively located in the second part 2112 and the fourth part 2212. According to actual conditions, parts of the first voice coil portion 321 and the second voice coil portion 322 may extend into the first part 2111 and the third part 2211. In addition, the first magnetic assembly 21 and the second magnetic assembly 22 respectively have magnetic flux lines passing through the first voice coil portion 321 and the second voice coil portion 322 at the positions of the second part 2112 and the fourth part 2212, forming vertically long magnetic field regions with uniform magnetic field distribution. This enables more and denser magnetic flux lines to pass through the voice coil 32, thereby providing a larger and smoother driving force that changes slowly with displacement, achieving a superlinear BL(x) design and reducing distortion risk, as shown in FIG. 9 and FIG. 10.

As shown in FIG. 2, FIG. 4 to FIG. 8, and FIG. 13 to FIG. 14, in an embodiment, in each vibration unit 30, the first voice coil portion 321 and the second voice coil portion 322 are wound by the same wire. The vibration plate 311 includes an inner vibration plate 3111 connected to an inner wall of the voice coil 32 and an outer vibration plate 3112 connected to an outer wall of the voice coil 32. In this embodiment, the first voice coil portion 321 and the second voice coil portion 322 are integrally designed and wound by the same wire to form a single voice coil 32, which is simple and convenient. The vibration plate 311 is divided by the voice coil 32 into the inner vibration plate 3111 and the outer vibration plate 3112, the inner vibration plate 3111 is connected to the inner wall of the voice coil 32, and the outer vibration plate 3112 is connected to the outer wall of the voice coil 32, thereby realizing the assembly of the voice coil 32 and the diaphragm 31.

In an embodiment, the first voice coil portion 321 and the second voice coil portion 322 are wound by the same wire to form an integrated voice coil 32 extending along the first direction. The voice coil 32 has a height along the first direction and a thickness along the second direction, and the height of the voice coil 32 is greater than the thickness of the voice coil 32. It should be noted that the thickness of the voice coil 32 refers to a distance between an inner wall surface and an outer wall surface of the annular voice coil. In this embodiment, the height of the voice coil 32 is greater than its thickness, such that during vibration, especially when the vibration amplitude is relatively large, the influence of magnetic field variation is small. The BL(x) curve is significantly flatter, distortion of the sound unit 100 is greatly reduced, and sound quality is improved. The voice coil 32 in this embodiment is applicable to full-band speakers, with an operating frequency range of 20 Hz to 20 kHz. In an embodiment, the ratio of the height dimension to the thickness dimension of the voice coil 32 is in a range of 1.1:1 to 10:1, and the specific ratio may be 1.1:1, 2:1, 3:1, 4:1, 5:1, 6:1, 7:1, 8:1, 9:1, or 10:1, which can be selected by a user according to actual needs.

In addition, two ends of the voice coil 32 are respectively opposite to the first part 2111 and the third part 2211, and the width of the voice coil 32 is smaller than the widths of the first part 2111 and the third part 2211. During vibration of the voice coil 32, the first voice coil portion 321 and the second voice coil portion 322 respectively extend into the first part 2111 and the third part 2211. The first part 2111 and the third part 2211 respectively provide avoidance spaces for their corresponding first voice coil portion 321 and second voice coil portion 322, so that when the thickness of the sound unit 100 is fixed, the vibration amplitudes of the first voice coil portion 321 and the second voice coil portion 322 can be ensured. In an embodiment, when the vibration amplitudes of the first voice coil portion 321 and the second voice coil portion 322 are fixed, the thickness of the sound unit 100 can be reduced, thereby facilitating a thinner design.

As shown in FIG. 2, FIG. 4, FIG. 6, FIG. 8, and FIG. 14, the first voice coil portion 321 and the second voice coil portion 322 are wound by the same wire. The vibration plate 311 includes an inner vibration plate 3111 connected to an inner wall of the voice coil 32 and an outer vibration plate 3112 connected to an outer wall of the voice coil 32. The inner vibration plate 3111 includes an inner flat plate portion 3114 and an inner bending portion extending from an outer edge of the inner flat plate portion 3114 and connected to the inner wall of the voice coil 32; and/or, the outer vibration plate 3112 includes an outer flat plate portion 3116 and an outer bending portion extending from an inner edge of the outer flat plate portion 3116 and connected to the outer wall of the voice coil 32. In this embodiment, the first voice coil portion 321 and the second voice coil portion 322 are integrally designed and wound by the same wire to form a single voice coil 32, which is simple and convenient. The vibration plate 311 is divided by the voice coil 32 into the inner vibration plate 3111 and the outer vibration plate 3112, the inner vibration plate 3111 is connected to the inner wall of the voice coil 32, and the outer vibration plate 3112 is connected to the outer wall of the voice coil 32, thereby realizing the assembly of the voice coil 32 and the diaphragm 31.

The inner vibration plate 3111 includes an inner flat plate portion 3114 and an inner bending portion 3115. The inner bending portion 3115 is formed by bending and extending from an outer edge of the inner flat plate portion 3114 along the first direction, that is, in the vertical direction, thereby enlarging a connection area with the inner wall of the voice coil 32 and improving the assembly stability between the inner vibration plate 3111 and the voice coil 32. The outer vibration plate 3112 includes an outer flat plate portion 3116 and an outer bending portion. The outer bending portion is formed by bending and extending from an inner edge of the outer flat plate portion 3116 along the first direction, that is, in the vertical direction, thereby enlarging a connection area with the outer wall of the voice coil 32 and improving the assembly stability between the outer vibration plate 3112 and the voice coil 32.

Alternatively, the first voice coil portion 321 and the second voice coil portion 322 are wound by the same wire. The vibration plate 311 includes an inner vibration plate 3111 connected to an inner wall of the voice coil 32 and an outer vibration plate 3112 connected to an outer wall of the voice coil 32. One side of the second voice coil portion 322 is connected to an external circuit. In this embodiment, the first voice coil portion 321 and the second voice coil portion 322 are integrally designed and wound by the same wire to form a single voice coil 32, which is simple and convenient. The vibration plate 311 is divided by the voice coil 32 into the inner vibration plate 3111 and the outer vibration plate 3112. The inner vibration plate 3111 is connected to the inner wall of the voice coil 32, and the outer vibration plate 3112 is connected to the outer wall of the voice coil 32, thereby realizing the assembly of the voice coil 32 and the diaphragm 31. In addition, one side of the second voice coil portion 322 is connected to an external circuit, thereby realizing electrical conduction between the voice coil 32 and the external circuit.

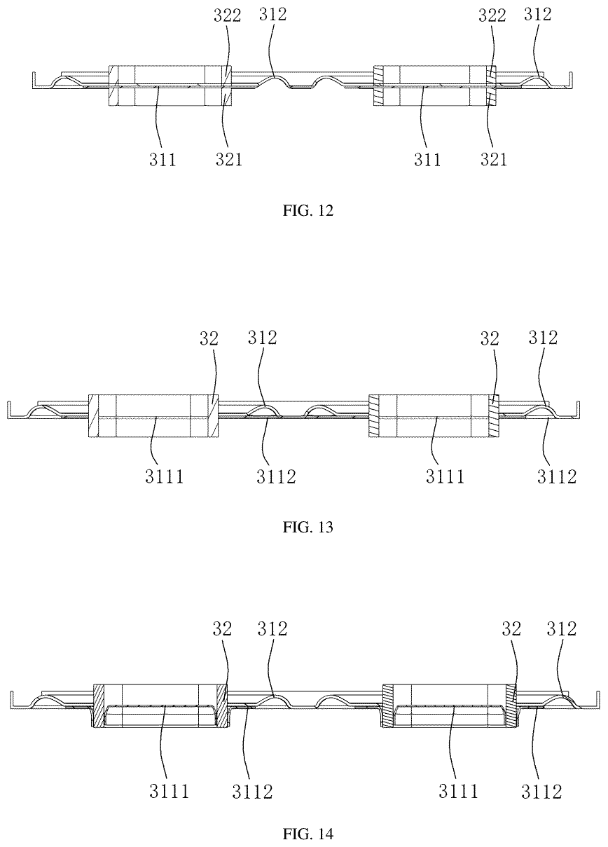

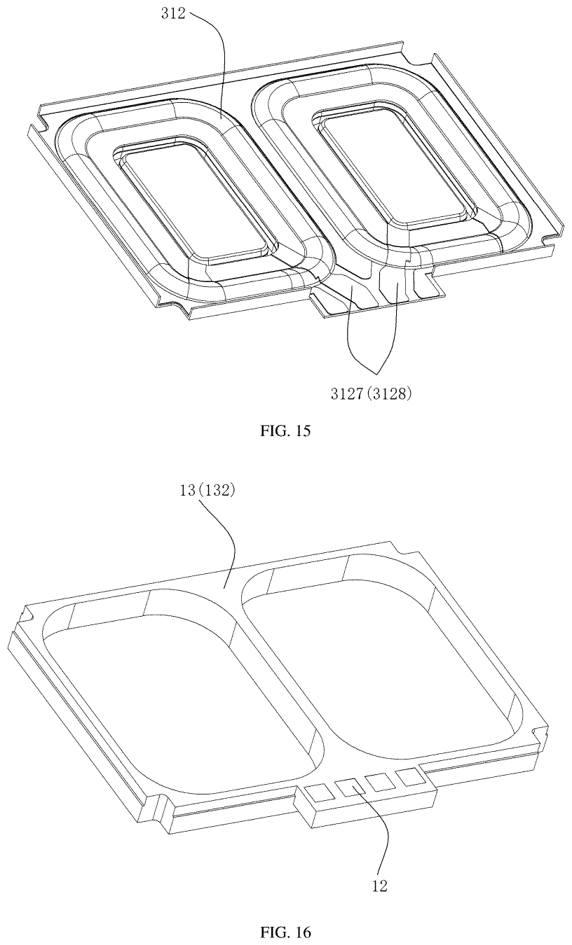

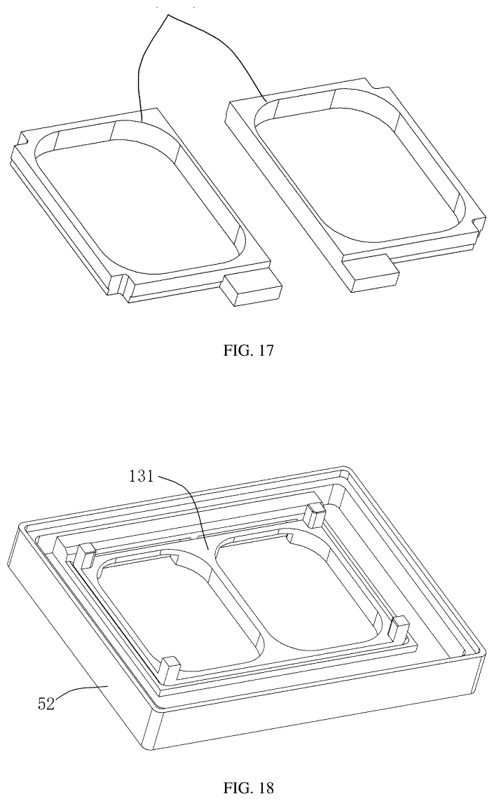

As shown in FIG. 3, FIG. 11, and FIG. 12, in another embodiment, the first voice coil portion 321 and the second voice coil portion 322 are respectively wound by different wires independently. In this embodiment, the first voice coil portion 321 and the second voice coil portion 322 are separately designed and independently wound by different wires to form a dual voice coil 32. The vibration plate 311 is not divided by the voice coil 32 and is formed as an integrated vibration plate 311.

As shown in FIG. 4, in other embodiments, in each vibration unit 30, the first voice coil portion 321 and the second voice coil portion 322 are wound by the same wire. The vibration plate 311 includes an inner vibration plate 3111 connected to an inner wall of the voice coil 32 and an outer vibration plate 3112 connected to an outer wall of the voice coil 32. The diaphragm 31 further includes a waterproof membrane 313. The waterproof membrane 313 is connected between the inner vibration plate 3111 and the outer vibration plate 3112, and is attached to and wraps around one end of the second voice coil portion 322 facing the second magnetic assembly 22.

In this embodiment, the first voice coil portion 321 and the second voice coil portion 322 are integrally designed and wound by the same wire to form a single voice coil 32, which is simple and convenient. The vibration plate 311 is divided by the voice coil 32 into an inner vibration plate 3111 and an outer vibration plate 3112. The inner vibration plate 3111 is connected to the inner wall of the voice coil 32, and the outer vibration plate 3112 is connected to the outer wall of the voice coil 32, thereby realizing the assembly of the voice coil 32 and the diaphragm 31.

In addition, the diaphragm 31 further includes a waterproof membrane 313. The waterproof membrane 313 connects the inner vibration plate 3111 and the outer vibration plate 3112 and is attached to an upper end of the second voice coil portion 322. The waterproof membrane 313 serves a waterproof function, thereby improving the waterproof performance and rating of the sound unit 100.

The voice coil 32 of the present application may adopt either a single voice coil 32 design or a dual voice coil 32 design, which can be flexibly selected according to actual requirements. As shown in FIG. 2 to FIG. 7 and FIG. 12 to FIG. 15, in two adjacent vibration units 30, the two folded rings 312 are connected to each other integrally, which facilitates manufacturing.

As shown in FIG. 8, in an embodiment, the sound unit 100 further includes a housing 10. In each vibration unit 30, the folded ring 312 includes a first connecting portion 3124, a deformable portion 3125, and a second connecting portion 3126 sequentially connected along the second direction. The first connecting portion 3124 is connected to the vibration plate 311, the second connecting portion 3126 is connected to the housing 10, and the deformable portion 3125 is recessed toward a side on which the second magnetic assembly 22 is located.

In this embodiment, the folded ring 312 is a horizontal folded ring 312. The folded ring 312 includes a first connecting portion 3124, a deformable portion 3125, and a second connecting portion 3126 sequentially connected along the horizontal direction. The first connecting portion 3124 is connected to the vibration plate 311, and the second connecting portion 3126 is connected to the housing 10 to achieve assembly with the housing 10. The deformable portion 3125 is recessed downward, which facilitates supporting and guiding the vertical vibration of the diaphragm 31. By designing the folded ring 312 as a horizontal folded ring 312, the structure is simplified, and the vertical movement of the diaphragm 31 can be better guided, maintaining linear vibration, reducing non-axial displacement, and further minimizing distortion.

As shown in FIG. 6, in another embodiment, the sound unit 100 further includes a housing 10. In each vibration unit 30, two ends of the folded ring 312 along the first direction are respectively a first end 3121 and a second end 3122. The first end 3121 is connected to an edge of the vibration plate 311, and the second end 3122 is connected to the housing 10 or to the second magnetic assembly 22. The first end 3121 is located on the same side as the first magnetic assembly 21, and the second end 3122 is located on the same side as the second magnetic assembly 22.

Specifically, two ends of the folded ring 312 along the vertical direction are respectively a first end 3121 and a second end 3122. The first end 3121 is connected to the vibration plate 311, and the second end 3122 is connected to the housing 10 or to the second magnetic assembly 22. The first end 3121 is located on the same side as the first magnetic assembly 21, and the second end 3122 is located on the same side as the second magnetic assembly 22. In this way, the folded ring 312 has a certain height in the vertical direction, that is, the folded ring 312 is a vertical folded ring 312 that extends in the vertical direction. This reduces the space occupied by the folded ring 312 in the horizontal direction, enlarges the size of the vibration plate 311 in the horizontal direction of the sound unit 100, increases an effective vibration area (SD) of the sound unit 100, improves the sensitivity of the sound unit 100, and optimizes the mid-frequency performance of the product.

As shown in FIG. 6, in an embodiment, the folded ring 312 includes a plurality of bending portions 3123 sequentially connected along the first direction. Each bending portion 3123 is bent toward the second direction, and bending directions of any two adjacent bending portions 3123 are opposite, so that the folded ring 312 forms a wavy curved structure. Two bending portions 3123 located at outermost sides along the first direction respectively form the first end 3121 and the second end 3122.

Specifically, the folded ring 312 includes a plurality of bending portions 3123 sequentially connected along the vertical direction. Each bending portion 3123 is bent toward the horizontal direction, and bending directions of any two adjacent bending portions 3123 are opposite, so that the folded ring 312 forms a wavy curved structure. Two bending portions 3123 located at outermost positions along the first direction respectively form the first end 3121 and the second end 3122, that is, the bending portion 3123 located at the uppermost side and the bending portion 3123 located at the lowermost side respectively form the first end 3121 and the second end 3122. By designing the folded ring 312 as a wavy curved structure that is arranged in the vertical direction and bent multiple times in the horizontal direction, the ductility of the folded ring 312 is improved, the space occupied by the folded ring 312 in the horizontal direction is further reduced, the size of the vibration plate 311 in the horizontal direction of the sound unit 100 is further enlarged, the effective vibration area of the sound unit 100 is further increased, the sensitivity of the sound unit 100 is further improved, and the mid-frequency performance is further optimized.

Each bending portion 3123 is an arc-shaped bending portion 3123, and any two adjacent bending portions 3123 are smoothly and continuously connected to each other, which improves the smoothness and continuity of the folded ring 312, avoids stress concentration, and is more conducive to enhancing the ductility of the folded ring 312.

In an embodiment, the folded ring 312 is connected to a side of the vibration plate 311 facing the second magnetic assembly 22, and the second end 3122 is arranged to surround the second magnetic assembly 22. As shown in FIG. 6, the folded ring 312 is connected to the side of the vibration plate 311 facing the second magnetic assembly 22, that is, the folded ring 312 is connected to a lower side of the vibration plate 311, and the second end 3122 surrounds an outer side of the second magnetic assembly 22, resulting in a reasonable structural design.

In an embodiment, a contour size of the second end 3122 projected along the first direction is greater than a contour size of the first end 3121 projected along the first direction. That is, when projected along the vertical direction, a contour size of the second end 3122 on the horizontal plane is greater than that of the first end 3121 on the horizontal plane. The first end 3121 and the second end 3122 are both annularly arranged. Compared with the first end 3121, the outer contour size of the second end 3122 is increased, which further improves the extensibility of the folded ring 312, reduces the space occupied by the folded ring 312 in the horizontal direction, enlarges the size of the vibration plate 311 in the horizontal direction of the sound unit 100, thereby increasing the effective vibration area of the sound unit 100, and improving the compliance of the folded ring 312.

In an embodiment, a contour of an outer edge of the vibration plate 311 projected along the first direction is located outside a contour of the second magnetic assembly 22 projected along the first direction. That is, when projected onto the horizontal plane, the contour of the outer edge of the vibration plate 311 is located outside the contour of the second magnetic assembly 22, such that the vibration plate 311 has a larger outer contour size, thereby increasing the effective vibration area of the sound unit 100.

In an embodiment, a contour of an outer edge of the vibration plate 311 projected along the first direction is located outside a contour of the first magnetic assembly 21 projected along the first direction. That is, when projected onto the horizontal plane, the contour of the outer edge of the vibration plate 311 is located outside the contour of the first magnetic assembly 21, such that the vibration plate 311 has a larger outer contour size, thereby increasing the effective vibration area of the sound unit 100.

In an embodiment, a position of the vibration plate 311 near its outer edge is bent and extended toward the first magnetic assembly 21 to form a slope structure, and the first magnetic assembly 21 is provided with a clearance portion for avoiding the slope structure. Specifically, the position of the vibration plate 311 near its outer edge is bent and extended upward to form the slope structure, and the clearance portion of the first magnetic assembly 21 allows avoidance of the slope structure to prevent interference between the first magnetic assembly 21 and the vibration plate 311.

As shown in FIG. 2 to FIG. 9 and FIG. 11, in an embodiment, the first magnetic assembly 21 includes a first inner magnet 212 and a first outer magnet 213 provided along the second direction. A first magnetic gap 211 is formed between the first inner magnet 212 and the first outer magnet 213. Magnetic flux lines passing through the first magnetic gap 211 can be generated between the first inner magnet 212 and the first outer magnet 213, so that when the first voice coil portion 321 is energized, the first voice coil portion 321 vibrates up and down to cut the magnetic flux lines.

The second magnetic assembly 22 includes a second inner magnet 222 and a second outer magnet 223 provided along the second direction. A second magnetic gap 221 is formed between the second inner magnet 222 and the second outer magnet 223. Magnetic flux lines passing through the second magnetic gap 221 can be generated between the second inner magnet 222 and the second outer magnet 223, so that when the second voice coil portion 322 is energized, the second voice coil portion 322 vibrates up and down to cut the magnetic flux lines.

A side of the first inner magnet 212 and the first outer magnet 213 facing the vibration plate 311 forms a surface of the first magnetic assembly 21, and a side of the second inner magnet 222 and the second outer magnet 223 facing the vibration plate 311 forms a surface of the second magnetic assembly 22.

As shown in FIG. 9, compared with the first part 2111 of the first magnetic gap 211 and the third part 2211 of the second magnetic gap 221, the first magnetic assembly 21 and the second magnetic assembly 22 mainly form magnetic field regions that are vertically elongated and have relatively uniform magnetic field distribution at the second part 2112 and the fourth part 2212, respectively, so as to provide the voice coil 32 with a larger and flatter driving force that changes slowly with displacement. As shown in FIG. 10, the BL(x) curve is nearly symmetrical about the center, and at the Xmax position (maximum displacement of the voice coil 32), the BL decreases by less than 10% compared with the equilibrium position, thereby achieving a super-linear BL(x) design and reducing distortion risk.

Meanwhile, compared with a structure in which magnetic conductive plates are provided on sides of the inner magnets and outer magnets of the two magnetic assemblies facing the vibration plate 311, in which the magnetic conductive plates concentrate magnetic flux lines and cause the magnetic flux lines to be relatively concentrated in the regions corresponding to the magnetic conductive plates, resulting in a non-uniform magnetic flux distribution in the regions where the first voice coil portion 321 and the second voice coil portion 322 are located, the sound unit 100 in this embodiment eliminates the magnetic conductive plates. As a result, the magnetic flux distribution corresponding to the first voice coil portion 321 and the second voice coil portion 322 becomes more uniform, the magnetic field variation experienced by the first voice coil portion 321 and the second voice coil portion 322 during vibration is reduced, the BL(x) curve is flatter, and vibration consistency is improved, thereby effectively reducing distortion and avoiding sound quality degradation. In addition, eliminating the magnetic conductive plates further reduces the size of the sound unit 100 along the first direction, facilitating a thinner structural design.

The first voice coil portion 321 and the second voice coil portion 322 may be entirely located in the second part 2112 and the fourth part 2212, respectively. Alternatively, the first voice coil portion 321 and the second voice coil portion 322 may be partially located in the second part 2112 and the fourth part 2212, respectively, and other portions of the first voice coil portion 321 and the second voice coil portion 322 may extend into the first part 2111 and the third part 2211, respectively. The above positional relationships are defined with respect to the assembled state of the sound unit. When portions of the first voice coil portion 321 and the second voice coil portion 322 extend into the first part 2111 and the third part 2211, respectively, the height of the first voice coil portion 321 and the second voice coil portion 322 increases, resulting in reduced influence from magnetic field variations during vibration, a flatter BL(x) curve, better vibration consistency, and effectively reduced distortion and sound quality loss. The first voice coil portion 321 and the second voice coil portion 322 may also be entirely located in the second part 2112 and the fourth part 2212, respectively, which allows for further reduction of the height of the sound unit 100 while meeting performance requirements.

In an embodiment, in each magnetic circuit unit 20, magnetic poles of the first inner magnet 212 and the second inner magnet 222 are opposite, magnetic poles of the first outer magnet 213 and the second outer magnet 223 are opposite, and magnetic poles of the first inner magnet 212 and the first outer magnet 213 are opposite. With this configuration, magnetic flux lines generated by the first inner magnet 212 and the second inner magnet 222 repel each other, and magnetic flux lines generated by the first outer magnet 213 and the second outer magnet 223 also repel each other. A closed annular magnetic loop is formed between the magnetic flux lines generated by the first outer magnet 213 and the first inner magnet 212, and another closed annular magnetic loop is formed between the magnetic flux lines generated by the second outer magnet 223 and the second inner magnet 222. The first magnetic assembly 21 and the second magnetic assembly 22 form magnetic field regions at the positions of the second part 2112 and the fourth part 2212 where magnetic flux lines pass through the first voice coil portion 321 and the second voice coil portion 322. These regions are vertically elongated and have relatively uniform magnetic field distribution, allowing more and denser magnetic flux lines to pass through the voice coil 32. As a result, the driving force is larger and flatter, changing slowly with displacement, thereby achieving a super-linear BL(x) design and reducing distortion risk, as shown in FIG. 9 and FIG. 10.

In an embodiment, the first magnetic gap 211 and the second magnetic gap 221 are aligned along the first direction, so that the first voice coil portion 321 located in the first magnetic gap 211 and the second voice coil portion 322 located in the second magnetic gap 221 are correspondingly aligned, thereby improving vibration consistency and avoiding deflection.

In an embodiment, the first outer magnet 213 is a ring magnet, which has good continuity and helps improve the uniformity of magnetic field distribution.

The first inner magnet 212 and the second inner magnet 222 are disposed opposite to each other, and the first outer magnet 213 and the second outer magnet 223 are disposed opposite to each other, which facilitates the alignment of the first magnetic gap 211 and the second magnetic gap 221. This allows the first voice coil portion 321 located in the first magnetic gap 211 and the second voice coil portion 322 located in the second magnetic gap 221 to be correspondingly aligned, thereby improving vibration consistency and avoiding deflection.

In an embodiment, a dimension of the first inner magnet 212 along the second direction is the same as that of the second inner magnet 222 along the second direction, and a dimension of the first outer magnet 213 along the second direction is the same as that of the second outer magnet 223 along the second direction. This helps improve the uniformity of magnetic field distribution and the symmetry in the vertical direction, resulting in a flatter BL(x) curve.

In another embodiment, a dimension of the first inner magnet 212 along the second direction is the same as that of the second inner magnet 222 along the second direction, and a dimension of the first outer magnet 213 along the second direction is smaller than that of the second outer magnet 223 along the second direction. Specifically, the first inner magnet 212 and the second inner magnet 222 have matching shapes, and the dimension of the first inner magnet 212 in the horizontal direction is the same as that of the second inner magnet 222 in the horizontal direction, which helps improve the uniformity of magnetic field distribution. Furthermore, the dimension of the first outer magnet 213 in the horizontal direction is smaller than that of the second outer magnet 223 in the horizontal direction, that is, an outer edge size of the first outer magnet 213 is smaller than an outer edge size of the second outer magnet 223. Compared with the second outer magnet 223, narrowing the outer edge of the first outer magnet 213 prevents interference between the first outer magnet 213 and the diaphragm 31.

As shown in FIG. 15, in an embodiment, in each vibration unit 30, a conductive layer 3127 is provided on a surface of the folded ring 312, and the voice coil 32 is electrically connected to the conductive layer 3127. The sound unit 100 further includes a housing 10, and a conductive terminal 12 is injection-molded on the housing 10. The conductive layer 3127 and the conductive terminal 12 are connected through conductive adhesive, so that the voice coil 32 is electrically connected to the conductive terminal 12 via the conductive layer 3127.

In an embodiment, a conductive layer 3127 is provided on a surface of the folded ring 312 on a side facing the second voice coil portion 322, that is, the conductive layer 3127 is provided on a lower surface of the folded ring 312. The second voice coil portion 322 is connected to the conductive layer 3127, and the conductive layer 3127 is connected to a conductive terminal 12 on the housing 10 through conductive adhesive. The conductive terminal 12 is electrically connected to an external circuit, so that the second voice coil portion 322 is electrically connected to the external circuit through the conductive layer 3127, thereby realizing conduction between the second voice coil portion 322 and the external circuit. The conductive terminal 12 is injection-molded into the housing 10, which improves the integration and compactness of the housing 10. In addition, the conductive layer 3127 on the surface of the folded ring 312 forms a conductive path 3128, enabling the folded ring 312 to also have electrical conductivity and achieve high structural integration.

In another embodiment, each vibration unit 30 further includes a centering support plate 40, the centering support plate 40 is conductive, and the second voice coil portion 322 is connected to an external circuit through the centering support plate 40.

As shown in FIG. 4 to FIG. 7, the centering support plate 40 is disposed at an end of the second voice coil portion 322 away from the diaphragm 31, that is, the centering support plate 40 is disposed at a bottom end of the second voice coil portion 322. The centering support plate 40 includes an inner fixing portion 41, an elastic arm portion 42, and an outer fixing portion 43. The inner fixing portion 41, the elastic arm portion 42, and the outer fixing portion 43 are sequentially connected from inside to outside along the second direction, that is, along the horizontal direction. The outer fixing portion 43 is connected to the housing 10, the inner fixing portion 41 is connected to the second voice coil portion 322, and the elastic arm portion 42 connects the inner fixing portion 41 and the outer fixing portion 43. The elastic arm portion 42 is elastic, allowing the inner fixing portion 41 to vibrate along with the second voice coil portion 322. The centering support plate 40 serves to center and support the voice coil 32, preventing polarization of the voice coil 32 and improving its vibration stability. The second magnetic assembly 22 has an avoidance space 224 for accommodating the corresponding centering support plate 40, specifically for avoiding the elastic arm portion 42 of the centering support plate 40. The layout is reasonable, and the centering support plate 40 and the magnetic circuit unit 20 do not interfere with each other. In addition, one side of the second voice coil portion 322 is connected to an external circuit, thereby realizing conduction between the voice coil 32 and the external circuit.

In addition, in each vibration unit 30, the centering support plate 40 is conductive, and the second voice coil portion 322 is connected to an external circuit through the centering support plate 40, thereby realizing conduction between the second voice coil portion 322 and the external circuit. The centering support plate 40 being conductive eliminates the need for additional conductive components, resulting in a higher degree of integration and a simplified structure.

As shown in FIG. 2 and FIG. 3, the sound unit 100 further includes a housing 10. The housing 10 has a plurality of accommodating spaces 11 distributed along the second direction, each accommodating space 11 correspondingly accommodating one magnetic circuit unit 20. The housing 10 includes a plastic bracket 13, a first metal plate 14, and a second metal plate 15 respectively disposed on both sides of the plastic bracket 13 along the first direction. The plastic bracket 13, the first metal plate 14, and the second metal plate 15 together enclose the accommodating spaces 11. The first magnetic assembly 21 is provided on the first metal plate 14, and the second magnetic assembly 22 is provided on the second metal plate 15. The first metal plate 14 is embedded in the first module housing 52, and the second metal plate 15 is embedded in the second module housing 53.

The housing 10 of the sound unit 100 has a plurality of accommodating spaces 11 distributed along the second direction, that is, the horizontal direction. Each accommodating space 11 correspondingly accommodates one magnetic circuit unit 20 and one vibration unit 30, such that the plurality of magnetic circuit units 20 and the plurality of vibration units 30 are both distributed along the horizontal direction.

In an embodiment, the first metal plate 14 and the second metal plate 15 are respectively disposed on upper and lower sides of the plastic bracket 13. The plastic bracket 13, the first metal plate 14, and the second metal plate 15 of the housing 10 together enclose the accommodating space 11, providing a reasonable structural design. In addition, the first magnetic assembly 21 is provided on the first metal plate 14, and the second magnetic assembly 22 is provided on the second metal plate 15, thereby achieving assembly between the housing 10 and the magnetic circuit unit 20. Furthermore, conductive terminals 12 are injection-molded on the plastic bracket 13, improving the integration and compactness of the plastic bracket 13.

The first module housing 52 and the second module housing 53 may both be plastic housings. The first metal plate 14 is embedded in the first module housing 52, and the second metal plate 15 is embedded in the second module housing 53, resulting in a compact structure.

During the assembly process of the sound module 200, the first module housing 52 can be supplied together with the first bracket 131, and the second module housing 53 can be supplied integrally with the second bracket 132, thereby improving assembly efficiency and convenience.

Furthermore, the first metal plate 14 and/or the second metal plate 15 are made of magnetic conductive materials, so that the first metal plate 14 and/or the second metal plate 15 have magnetic conductivity, which facilitates correction of magnetic flux lines.

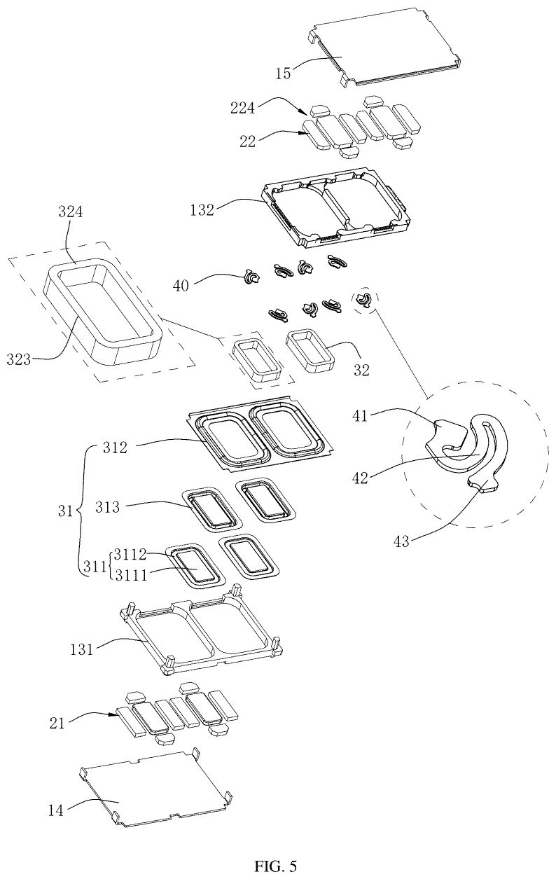

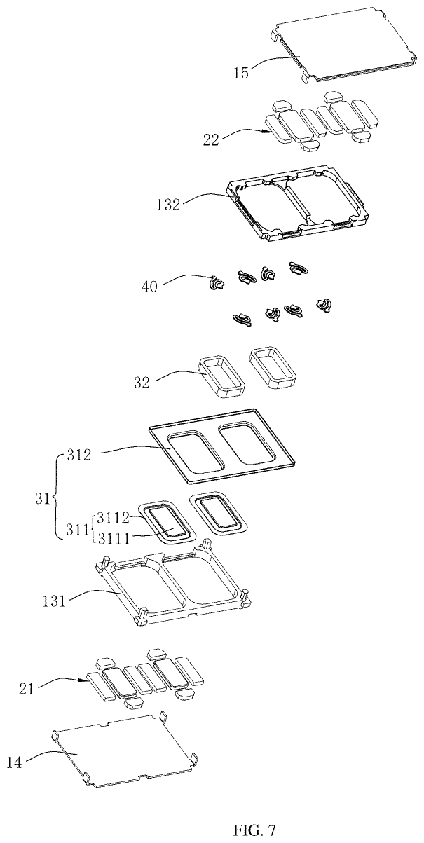

As shown in FIG. 2, FIG. 3, FIG. 5, and FIG. 7, in an embodiment, the plastic bracket 13 includes a first bracket 131 and a second bracket 132. The first bracket 131 and the second bracket 132 are separately designed along the first direction, that is, the vertical direction, which facilitates assembly and disassembly. The first bracket 131, the second bracket 132, the first metal plate 14, and the second metal plate 15 together enclose the accommodating space 11. The first bracket 131 surrounds the first magnetic assembly 21, and the second bracket 132 surrounds the second magnetic assembly 22. Conductive terminals 12 are injection-molded on the second bracket 132, providing a reasonable structural design.

In an embodiment, the sound outlet holes 54 are located on the same side wall of the housing 50. It can be understood that a plurality of vibration units 30 respectively correspond to a plurality of sound outlet holes 54 and emit sound from the corresponding sound outlet holes 54. The plurality of sound outlet holes 54 are located on the same side wall of the housing 50, which facilitates manufacturing and provides a reasonable design, enabling the sound module 200 to emit sound from one side.

In an embodiment, in each vibration unit 30, the first voice coil portion 321 and the second voice coil portion 322 are wound by the same wire. The vibration plate 311 includes an inner vibration plate 3111 connected to an inner wall of the voice coil 32 and an outer vibration plate 3112 connected to an outer wall of the voice coil 32. In this embodiment, the first voice coil portion 321 and the second voice coil portion 322 are integrally designed and wound by the same wire, forming a single voice coil 32 structure that is simple and convenient. The vibration plate 311 is separated by the voice coil 32 into the inner vibration plate 3111 and the outer vibration plate 3112, the inner vibration plate 3111 is connected to the inner wall of the voice coil 32, and the outer vibration plate 3112 is connected to the outer wall of the voice coil 32, thereby achieving assembly between the voice coil 32 and the diaphragm 31.

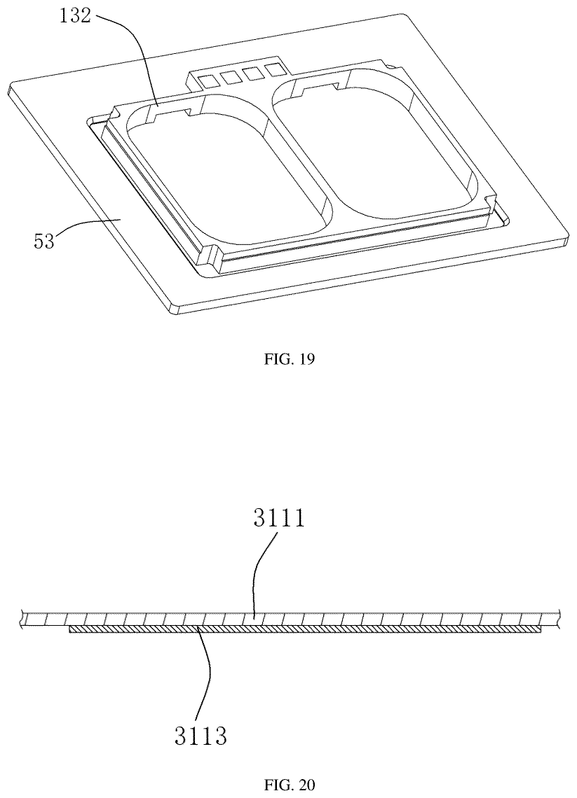

The magnetic poles of the first inner magnet 212 and the second inner magnet 222 are opposite in direction. As shown in FIG. 20, the inner vibration plate 3111 includes a magnetic conductive portion 3113. During vibration, due to the effect of the magnetic conductive portion 3113, the inner vibration plate 3111 can be subjected to an attractive force from the first magnetic assembly 21 and the second magnetic assembly 22. Specifically, when the inner vibration plate 3111 vibrates toward the first magnetic assembly 21, the resultant attraction of the first magnetic assembly 21 and the second magnetic assembly 22 on the magnetic conductive portion 3113 is directed toward the first magnetic assembly 21, which helps assist the inner vibration plate 3111 to move upward. When the inner vibration plate 3111 vibrates toward the second magnetic assembly 22, the resultant attraction of the first magnetic assembly 21 and the second magnetic assembly 22 on the magnetic conductive portion 3113 is directed toward the second magnetic assembly 22, which helps assist the inner vibration plate 3111 to move downward. Therefore, the design of the magnetic conductive portion 3113 can assist the vibration of the inner vibration plate 3111 and improve the sound emission performance.

In an embodiment, the inner vibration plate 3111 is a magnetically conductive plate member to form the magnetic conductive portion 3113. That is, the inner vibration plate 3111 itself is a magnetically conductive plate member having magnetic conductivity to form the magnetic conductive portion 3113, without the need to additionally provide another magnetic conductive portion 3113, resulting in a simple structure.

In an embodiment, a magnetic conductive member is embedded inside the inner vibration plate 3111 to form the magnetic conductive portion 3113. Embedding the magnetic conductive member inside the inner vibration plate 3111 provides good structural consistency and compactness.

In an embodiment, at least one side of the inner vibration plate 3111 along the first direction is provided with a magnetic conductive member to form the magnetic conductive portion 3113. For example, a magnetic conductive member is provided on an upper side of the inner vibration plate 3111. As another example, a magnetic conductive member is provided on a lower side of the inner vibration plate 3111, as shown in FIG. 20. As a further example, magnetic conductive members are provided on both upper and lower sides of the inner vibration plate 3111.

In an embodiment, at least one surface of the inner vibration plate 3111 along the first direction is coated with a magnetic conductive material to form the magnetic conductive portion 3113. For example, the upper surface of the inner vibration plate 3111 is coated with a magnetic conductive material. As another example, the lower surface of the inner vibration plate 3111 is coated with a magnetic conductive material. As a further example, both the upper and lower surfaces of the inner vibration plate 3111 are coated with magnetic conductive materials.

The formation and position of the magnetic conductive portion 3113 of the present application can be set according to actual needs, with various setting methods and high flexibility.

In an embodiment, the number of accommodating spaces 11 is two, and the numbers of the magnetic circuit units 20 and the vibration units 30 are consistent with the number of the accommodating spaces 11 and correspond one-to-one.

The number of accommodating spaces 11 can be flexibly set according to actual needs. In this embodiment, the number of accommodating spaces 11 is set to two, which is not excessive and facilitates the miniaturized design of the sound unit 100.

In addition, when the number of accommodating spaces 11 is set to two, the numbers of the magnetic circuit units 20 and the vibration units 30 are both two. Each accommodating space 11 is provided with one magnetic circuit unit 20 and one vibration unit 30. The two accommodating spaces 11 can be arranged side by side along a short-axis edge 324 of the voice coil 32. It can be understood that the short-axis edge 324 has a shorter dimension, and the long-axis edge 323 has a longer dimension. Since the short-axis edge 324 occupies less space than the long-axis edge 323, arranging the two accommodating spaces 11 side by side along the short-axis edge 324 of the voice coil 32 ensures that the size of the housing 10 is not excessively long, resulting in a reasonable structural design.

In an embodiment, the rear cavity 512 is filled with a sound-absorbing material, the second module housing 53 is provided with a filling port for the sound-absorbing material, and the second module housing 53 further includes a damping member for covering the filling port. Filling the rear cavity 512 with the sound-absorbing material can adjust the acoustic performance of the sound module 200. The filling port provided in the second module housing 53 allows the sound-absorbing material to be filled into the rear cavity 512. After the filling is completed, the damping member covers the filling port to prevent the sound-absorbing material from leaking.

In an embodiment, the first bracket 131 may adopt an integrated design or a split design. The integrated first bracket 131 is easy to manufacture, eliminates assembly gaps and assembly errors, and has a compact structure. The split first bracket 131 is convenient for disassembly and assembly and has high flexibility. When the first bracket 131 adopts the split design, each accommodating space 11 is correspondingly provided with one first bracket 131.

The second bracket 132 may adopt an integrated design or a split design. The integrated second bracket 132 is easy to manufacture, eliminates assembly gaps and assembly errors, and has a compact structure. The split second bracket 132 is convenient for disassembly and assembly and has high flexibility. When the second bracket 132 adopts the split design, each accommodating space 11 is correspondingly provided with one second bracket 132.

A plurality of vibration units 30 may respectively adopt independent rear cavities 512 or share a common rear cavity 512, which can be flexibly set according to actual conditions.

The present application further provides an electronic device, which includes a device housing and the above sound module. The specific structure of the sound module in the electronic device refers to the above embodiments. Since the electronic device adopts all the technical solutions of the above embodiments, it therefore possesses at least all the advantageous effects brought by the technical solutions of the above embodiments, and detailed descriptions thereof are omitted here.

The above are only some embodiments of the present application, and do not limit the scope of the present application thereto. Under the inventive concept of the present application, equivalent structural transformations made based on the description and drawings of the present application, or direct/indirect application in other related technical fields are included in the scope of the present application.

What is claimed is:

1. A sound module, comprising:
a housing; and
a sound unit,
wherein the housing comprises a first module housing and a second module housing provided along a first direction, the first module housing and the second module housing are enclosed to form an accommodating cavity;
the sound unit is accommodated in the accommodating cavity and forms a front cavity and a rear cavity between the sound unit and the housing; and
the sound unit comprises a magnetic circuit system and a vibration system, wherein:
the magnetic circuit system comprises a plurality of magnetic circuit units distributed along a second direction, each of the magnetic circuit units comprises a first magnetic assembly and a second magnetic assembly spaced apart along the first direction, the second direction is perpendicular to the first direction, the first magnetic assembly has a first magnetic gap, and the second magnetic assembly has a second magnetic gap;
the vibration system comprises a plurality of vibration units, each magnetic circuit unit corresponds to one vibration unit, each vibration unit is provided between the first magnetic assembly and the second magnetic assembly of the corresponding magnetic circuit unit, each vibration unit comprises a diaphragm and a voice coil connected to the diaphragm, the diaphragm comprises a vibration plate and a folded ring provided around the vibration plate along the second direction, the voice coil comprises a first voice coil portion and a second voice coil portion located on opposite sides of the vibration plate along the first direction, the first voice coil portion is located in the first magnetic gap of the corresponding magnetic circuit unit, and the second voice coil portion is located in the second magnetic gap of the corresponding magnetic circuit unit; and
in a first working state, at least one of the vibration units radiates sound waves of a first phase outward, and at least one of the remaining vibration units radiates sound waves of a second phase outward, the first phase and the second phase are opposite phases; the housing is provided with a sound outlet hole corresponding to each of the vibration units, the sound outlet hole communicates with the front cavity, and the sound waves generated by each of the vibration units are radiated outward through the corresponding sound outlet hole.

2. The sound module according to claim 1, wherein:
in the first working state, two adjacent vibration assemblies respectively radiate sound waves of the first phase and the second phase outward, each of the vibration assemblies comprises one vibration unit or multiple adjacent vibration units, and numbers of the vibration units in the two adjacent vibration assemblies are the same; or
a difference in the numbers of the vibration units in the two adjacent vibration assemblies is one or two.

3. The sound module according to claim 1, wherein:
in a second working state, the plurality of vibration units radiate sound waves of the same phase outward, and the second working state differs from the first working state.

4. The sound module according to claim 1, wherein in each of the vibration units, the first voice coil portion and the second voice coil portion are wound by a same wire, and the vibration plate comprises an inner vibration plate connected to an inner wall of the voice coil and an outer vibration plate connected to an outer wall of the voice coil.

5. The sound module according to claim 4, wherein the inner vibration plate comprises an inner flat plate portion and an inner bending portion extending from an outer edge of the inner flat plate portion and connected to the inner wall of the voice coil; and/or, the outer vibration plate comprises an outer flat plate portion and an outer bending portion extending from an inner edge of the outer flat plate portion and connected to the outer wall of the voice coil.

6. The sound module according to claim 4, wherein one side of the second voice coil portion is connected to an external circuit.

7. The sound module according to claim 1, wherein in each of the vibration units, the first voice coil portion and the second voice coil portion are respectively wound by different conductive wires independently.

8. The sound module according to claim 1, wherein:
the first magnetic gap comprises a first part opposite to the first magnetic assembly in the second direction, and a second part located on a side of the first part facing the vibration plate in the first direction;
the second magnetic gap comprises a third part opposite to the second magnetic assembly in the second direction, and a fourth part located on a side of the third part facing the vibration plate in the first direction; and
magnetic flux lines of the first magnetic assembly pass through the first voice coil portion at the second part and magnetic flux lines of the second magnetic assembly pass through the second voice coil portion at the fourth part.

9. The sound module according to claim 8, wherein:
the first voice coil portion and the second voice coil portion are wound from a same wire to form an integrated voice coil extending along the first direction, the voice coil has a height along the first direction and a thickness along the second direction, the height of the voice coil is greater than the thickness of the voice coil; two ends of the voice coil respectively oppose the first part and the third part, and a width of the voice coil is less than widths of the first part and the third part; or
part or all of the first voice coil portion is located in the second part and part or all of the second voice coil portion is located in the fourth part.

10. The sound module according to claim 1, wherein:
the sound unit further comprises a housing;
in each of the vibration units, the folded ring comprises a first connecting portion, a deformable portion, and a second connecting portion sequentially connected along the second direction, the first connecting portion is connected to the vibration plate, the second connecting portion is connected to the housing, and the deformable portion is recessed toward a side on which the second magnetic assembly is located; or
in each of the vibration units, two ends of the folded ring along the first direction are respectively a first end and a second end, the first end is connected to an edge of the vibration plate, the second end is connected to the housing or to the second magnetic assembly, the first end is located on a same side as the first magnetic assembly, and the second end is located on a same side as the second magnetic assembly.

11. The sound module according to claim 1, wherein:
the first magnetic assembly comprises a first inner magnet and a first outer magnet provided along the second direction, and the first magnetic gap is formed between the first inner magnet and the first outer magnet;
the second magnetic assembly comprises a second inner magnet and a second outer magnet provided along the second direction, and the second magnetic gap is formed between the second inner magnet and the second outer magnet; and
sides of the first inner magnet and the first outer magnet facing the vibration plate form a surface of the first magnetic assembly, and sides of the second inner magnet and the second outer magnet facing the vibration plate form a surface of the second magnetic assembly.

12. The sound module according to claim 11, wherein:
in each of the magnetic circuit units, magnetic poles of the first inner magnet and the second inner magnet are opposite, magnetic poles of the first outer magnet and the second outer magnet are opposite, and magnetic poles of the first inner magnet and the first outer magnet are opposite; and/or
the first magnetic gap and the second magnetic gap are aligned along the first direction; and/or
the first outer magnet is a ring magnet; and/or
the first inner magnet and the second inner magnet are provided opposite to each other, and the first outer magnet and the second outer magnet are provided opposite to each other.

13. The sound module according to claim 1, wherein:
in each of the vibration units, a conductive layer is provided on a surface of the folded ring, and the voice coil is electrically connected to the conductive layer;
the sound unit further comprises a housing, and a conductive terminal is injection-molded onto the housing; the conductive layer and the conductive terminal are connected via conductive adhesive, such that the voice coil is electrically connected to the conductive terminal through the conductive layer; or
each of the vibration units further comprises a centering support plate, the centering support plate is conductive, and the second voice coil portion is connected to an external circuit via the centering support plate.

14. The sound module according to claim 1, wherein:
the sound unit further comprises a housing, the housing has a plurality of accommodating spaces distributed along the second direction, each accommodating space is configured to accommodate one magnetic circuit unit correspondingly;
the housing comprises a plastic bracket, a first metal plate, and a second metal plate respectively provided on both sides of the plastic bracket along the first direction, the plastic bracket, the first metal plate, and the second metal plate encloses the accommodating spaces, the first magnetic assembly is provided on the first metal plate, and the second magnetic assembly is provided on the second metal plate; and
the first metal plate is embedded in the first module housing, and the second metal plate is embedded in the second module housing.

15. The sound module according to claim 14, wherein:
the first metal plate and/or the second metal plate are made of magnetic conductive materials;
and/or, the sound outlet holes are provided on a same side wall of the housing.

16. The sound module according to claim 11, wherein:
in each of the vibration units, the first voice coil portion and the second voice coil portion are wound by the same wire, and the vibration plate comprises an inner vibration plate connected to an inner wall of the voice coil and an outer vibration plate connected to an outer wall of the voice coil; and
the magnetic poles of the first inner magnet and the second inner magnet are opposite, and the inner vibration plate has a magnetic conductive portion.

17. The sound module according to claim 16, wherein:
the inner vibration plate is magnetically conductive to form the magnetic conductive portion; or
a magnetic conductive member is embedded in the inner vibration plate to form the magnetic conductive portion; or
a magnetic conductive member is provided on at least one side of the inner vibration plate along the first direction to form the magnetic conductive portion; or
at least one surface of the inner vibration plate along the first direction is coated with a magnetic conductive material to form the magnetic conductive portion.

18. The sound module according to claim 1, wherein:
the rear cavity is filled with a sound-absorbing material, the second module housing is provided with a filling port for the sound-absorbing material, and the second module housing further comprises a damper for sealing the filling port.

19. An electronic device, comprising a device housing and the sound module according to claim 1.
